(19) United States
(12) Patent Application Publication
(10) Pub. No.: US 2007/0198335 A1
(43) Pub. Date: Aug. 23, 2007

(54) System and method for providing loyalty rewards to an assistant designated to manage a financial transaction account

(75) Inventors: Brent M. Edwards, Thornhill (CA); Marc C. Rosenfeld, Thornhill (CA); Jane H.C. Thompson, Markham (CA)

Correspondence Address: FITZPATRICK CELLA (AMEX), 30 ROCKEFELLER PLAZA, NEW YORK, NY, 10112, US

(73) Assignee: American Express Marketing & Development Corp., a New York Corporation, New York, NY (US)

(21) Appl. No.: 11/246,139

(22) Filed: Oct. 11, 2005

(51) Int. Cl. G06Q 30/00

(52) U.S. Cl. 705/14; 235/380

(57) ABSTRACT

Systems, methods and computer program products for rewarding a holder of a transaction account linked to a financial transaction instrument, and rewarding an assistant who has been designated by the transaction account holder to manage the transaction account, the transaction account holder and the assistant each participating in a loyalty program. A first loyalty account associated with the transaction account is created for the transaction account holder. A second loyalty account associated with the transaction account is created for the assistant. A first reward is provided to the first loyalty account of the transaction account holder and a second reward is provided to the second loyalty account of the assistant, based on at least one transaction made using the financial transaction instrument.

### BACKGROUND OF THE INVENTION

1. Field of the Invention

The present invention generally relates to providing loyalty rewards to an assistant designated to manage a financial transaction account, and more particularly to a program that provides loyalty rewards both to a holder of a financial transaction instrument associated with the transaction account and to an assistant designated to manage the transaction account.

2. Related Art

Conventional loyalty reward programs for financial transaction instruments associated with transaction accounts (e.g., charge cards, credit cards, debit cards and the like) provide rewards for transactions made with the instrument. An example loyalty rewards program is the Membership Rewards® (MR) program provided by American Express. This practice is done in order to encourage increased spending with the card and continued customer loyalty to the instrument's issuer. In some cases, transactions with particular merchants who are in partnership with the card issuer may result in the card holder being rewarded additional loyalty benefits (e.g., double points) in order to encourage spending with that merchant (e.g., a particular airline or rental car company). Such benefits are commonly collected in a loyalty account associated with the transaction account. Thus, only the card holder receives the loyalty rewards, regardless of who performs the transactions with the card.

Card holders, who are enrolled in such loyalty programs by virtue of their transaction account, are increasingly delegating management of their transaction accounts to designated assistants (e.g., a secretary, an associate, an administrative assistant, an executive assistant and the like). These designated assistants may conduct most of the transactions made using the card, including, for example, making hotel reservations, purchasing airline tickets, renting cars, etc. Among the drawbacks of conventional loyalty reward programs is that these designated assistants, who are often integral in conducting transactions on behalf of the card holder, are in no way recognized for their management and use of the transaction account. Consequently, absent specific instructions from the card holder, there is no incentive for such assistants to increase spending with the card, maintain loyalty to the card issuer, or conduct business with the card issuer's partners.

Furthermore, organizations whose employees use financial transaction instruments to conduct company business may establish policies related to the above conventional loyalty programs, specifying the particular merchants with whom the organization is associated, e.g., hotel partners, airline partners, car rental partners, etc. Such policies may additionally outline which employees are permitted to spend funds and up to what amounts. With conventional loyalty programs, organizations may encounter difficulty in ensuring that employees adhere to the prescribed policies, because there is again no incentive for employees to transact with specific partners.

Given the foregoing, what is needed is a system, method, and computer program product for providing loyalty rewards to an assistant designated to manage a financial transaction account. Further, there is a need for an assistant loyalty program that rewards assistants for partner loyalty, spending habits, and general usage of the financial transaction instrument, in addition to rewarding the card holder.

### BRIEF DESCRIPTION OF THE INVENTION

The present invention meets the above-identified needs by providing a system, method and computer program product for providing loyalty rewards to an assistant designated to manage a financial transaction account.

In accordance with one embodiment of the present invention, there is provided a method for rewarding a holder of a transaction account linked to a financial transaction instrument, and rewarding an assistant who has been designated by the transaction account holder to manage the transaction account, the transaction account holder and the assistant each participating in a loyalty program, that proceeds by creating for a transaction account holder a first loyalty account associated with the transaction account. The method further includes creating for the assistant a second loyalty account associated with the transaction account. The method further requires providing a first reward to the first loyalty account of the transaction account holder and providing a second reward to the second loyalty account of the assistant, based on at least one transaction made using the financial transaction instrument.

In accordance with another embodiment of the present invention, there is provided a method for rewarding a holder of a transaction account linked to a financial transaction instrument, and rewarding an assistant who has been designated by the transaction account holder to manage the transaction account, the transaction account holder and the assistant each participating in a loyalty program, wherein providing the first reward to the first loyalty account and the second reward to the second loyalty account is additionally based on a relationship of a partner with the loyalty program.

In accordance with yet another embodiment of the present invention, there is provided a method for rewarding a holder of a transaction account linked to a financial transaction instrument, and rewarding an assistant who has been designated by the transaction account holder to manage the transaction account, the transaction account holder and the assistant each participating in a loyalty program, that further includes accepting a designation of at least one level of management access at which the assistant is authorized to manage the transaction account.

In accordance with yet another embodiment of the present invention, there is provided a method for rewarding a holder of a transaction account linked to a financial transaction instrument, and rewarding an assistant who has been designated by the transaction account holder to manage the transaction account, the transaction account holder and the assistant each participating in a loyalty program, that further includes creating for the transaction account holder the first loyalty account and creating for the assistant a second loyalty account at a single integrated server.

An advantage of the present invention is that it rewards not only the account holders, but also their assistants who in most instances conduct the majority of transactions, along with all related aspects, on the financial transaction instrument. Loyalty rewards provide the necessary incentive for such assistants to abide by an employer's company policy regarding particular partners and limits on spending.

Another advantage of the present invention is that it adapts the loyalty rewards program concept currently associated only with consumer financial transaction instruments for the corporate card environment.

Yet another advantage of the present invention is its compatibility with different forms of loyalty rewards programs. That is, by not being limited to a fixed type of loyalty reward, the present invention may be implemented so that, for instance, the account holder and designated assistant(s) may earn the same rewards value on completed transactions, or different values.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating a transaction accounts system and a designated assistant system, both linked to a loyalty system maintained by the transaction instrument issuer and connected to a loyalty rewards system, in accordance with one embodiment of the present invention.

FIG. 2 is a block diagram illustrating a transaction accounts system and a designated assistant system, both of which maintained by the transaction instrument issuer and connected to a loyalty rewards system, in accordance with one embodiment of the present invention.

FIG. 3 is a block diagram illustrating an integrated transaction accounts-designated assistant system maintained by the transaction instrument issuer, and connected to a loyalty rewards system, in accordance with one embodiment of the present invention.

FIG. 4 is a flowchart illustrating a process for establishing a transaction account and corresponding loyalty account, along with designation of an assistant for management or administration of the transaction account and establishment of an assistant loyalty account, in accordance with one embodiment of the present invention.

FIG. 5 is a flowchart illustrating a process for awarding loyalty rewards to both the account holder and designated assistant after completion of a transaction with the financial transaction instrument in accordance with one embodiment of the present invention.

FIG. 6 is a block diagram of an exemplary computer system useful for implementing the present invention.

### DETAILED DESCRIPTION

I. Overview

The present invention is described in more detail herein in terms of an exemplary implementation. This is for convenience only and is not intended to limit the application of the present invention.

Generally, the present invention is directed toward a system, method and computer program product for providing loyalty rewards to an assistant for management of a financial transaction account. Once an assistant has been designated, that is, authorized by a transaction account holder, they may administer the transaction account, including making at least certain purchases, subject to the limitations set by the account holder. As purchases and transactions are conducted via the financial transaction instrument, both the designated assistant as well as the account holder receive loyalty rewards in their respective loyalty accounts, linked to the transaction account.

During enrollment into a transaction account linked to a financial transaction instrument, the transaction instrument issuer further establishes a loyalty account for the account holder, the first such loyalty account associated with the holder's transaction account. The account holder's information is entered into both a transaction accounts system and loyalty system, and is periodically forwarded to a loyalty rewards system.

The assistant may be designated as part of the initial application process for the transaction account. Alternatively, the assistant may be designated in an enrollment process relating to an existing transaction account. In either case, information about the designated assistant is entered into the transaction instrument issuer's system (e.g., a separate server linking designated assistants with the corresponding transaction accounts) and processed, so that it may later be accessed by individual transaction account service operators for verification purposes.

At the same time, a second, separate loyalty account linked to the transaction account of the holder is established for the designated assistant. Loyalty information relating to transactions performed by the assistant is likewise periodically forwarded to the loyalty rewards system. Additionally, at any time the account holder may add a designation of another assistant, or change or cancel designated assistant authorization by submitting the appropriate forms.

Once this information is stored in the issuer's designated assistant system, the designated assistant is then authorized to manage the transaction account on behalf of the account holder, to an extent dependent on the level of access, as discussed below. The management functions performed by the designated assistant may include, for example, obtaining statements, reviewing and verifying transactions, disputing transactions, setting up automated account alerts, and disputing finance changes and late fees. Furthermore, it may be the case that the designated assistant is authorized to conduct certain categories of purchases or make specific representations using the financial transaction instrument, on behalf of the account holder. For instance, in the context of a corporate card, a designated assistant may be authorized to make travel arrangements, such as purchasing airline tickets and making lodging reservations, for the account holder.

The present invention may provide an account holder with the option of setting a particular level of access at which the designated assistant is authorized to manage the transaction account. Each of the levels corresponds to a predetermined set of management functions the assistant is allowed to perform. Alternatively, the system may provide only a single level of access for designated assistants, which includes a predetermined subset of management functions. It is also within the scope of the present invention, however, to provide the account holder with the ability to select individual authorization rights, in effect defining a customized level of authorization to meet that account holder's needs.

If multiple access levels are provided, the broadest level may give the designated assistant unrestricted access to perform any function associated with the transaction account that can be performed by the account holder, including making a purchase. Alternatively, the broadest level of access may exclude certain functions, such as the ability to make purchases and to change the mailing address for the account. The other levels restrict the assistant to particular subsets of the management functions associated with the transaction account. For example, a level may be provided that only allows the assistant to view and retrieve transaction data. Another level may permit the assistant also to request and obtain from an operator additional detail about and back-up documentation for particular transactions, to dispute any that the account holder may believe not to be genuine, and the assistant may in addition be authorized at this level to advise the transaction card issuer that the account holder disputes a particular charge, either by speaking with an operator, via e-mail or using a web page, according to the means permitted by the transaction card issuer for such communications. Particularly if the assistant has a relatively high level of authorization permitting them to advise the transaction card issuer that a charge is disputed or to change contact information of the account holder, the issuer can send a confirmatory communication to the account holder alone, or to both the account holder and the assistant. Again, in designating the assistant, the account holder may be given the ability to select within certain limits to whom and under what circumstances such confirmatory messages will be sent.

As purchases are made from particular partners using the financial transaction instrument, loyalty rewards are awarded to both the account holder and the designated assistant. These loyalty rewards are accumulated separately in each party's respective loyalty account, linked to the transaction account.

Advantageously, the present invention applies a similar loyalty rewards program as those conventionally known in the consumer context of financial transaction instruments to the separate context of corporate cards. In so doing, the present invention offers incentives for designated assistants that manage the transaction accounts of employers, in order to encourage spending with particular partners and thus improve compliance with a business's established spending policies.

The terms “user”, “end user”, “consumer”, “customer”, “participant”, “owner”, “requestor” and/or the plural form of these terms are used interchangeably herein to refer to those persons or entities capable of accessing, using, being affected by and/or benefiting from the present invention.

The term “designated assistant” refers to any individual who is given authorization by a transaction account holder to manage or administer that holder's transaction account. The designated assistant may be, for example, an executive assistant who works for or is supervised by the account holder.

A “financial instrument issuer” is any entity that maintains a transaction account for customers to conduct financial transactions using a financial transaction instrument. An example of such an entity is American Express, or any other company that provides members with transaction instruments and thereby maintains corresponding transaction accounts.

“Management” is used interchangeably with “administration” and may encompass any action or function performed by a designated assistant with respect to the transaction account that could likewise be performed by the account holder, or a subset of such actions. By extension, the term “management instruction” includes any means for causing the account issuer to execute a management action, such as for example, a telephone call to a customer service operator. In other instances, management may even include making certain categories of purchases by the designated assistant, using the transaction instrument.

“Loyalty rewards” may be any sort of general benefits that an account holder or designated assistant accumulates for management functions with the transaction account or purchases made from particular partners. Such rewards may appear as data, generated at the time of transaction, and are awarded in a physical embodiment such as, for example, a printable coupon to a particular assistant or holder. These rewards may later be redeemed for any number of benefits including, but not limited to, money back on select purchases, points applied toward future discount prices, eligibility for sweepstakes, free merchandise offered by specific partners, and other types of rewards not specifically recited herein.

Furthermore, the terms “business”, “merchant”, “vendor”, “service” and/or “representative” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an online merchant or the like.

Similarly, a “partner” is any person, entity, distributor system, software and/or hardware that is a provider, broker and/or any other entity in the distribution chain of goods or services, that has a pre-existing contractual arrangement with the financial instrument issuer to provide loyalty rewards to account holders for financial transactions with that particular partner.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:

N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember. A merchant account number may be, for example, any number or alpha-numeric characters that identifies a particular merchant for purposes of card acceptance, account reconciliation, reporting and the like.

Further, a “loyalty account” can be any database or electronic entry that collects, stores and tabulates the number and type of loyalty rewards for a particular individual. This loyalty account is configured to allow a consumer to access, interact with, or communicate the information therein to a financial transaction system. As will be explained in greater detail below, a loyalty account may be maintained by either the transaction instrument issuer or, alternatively, a separate entity.

II. System

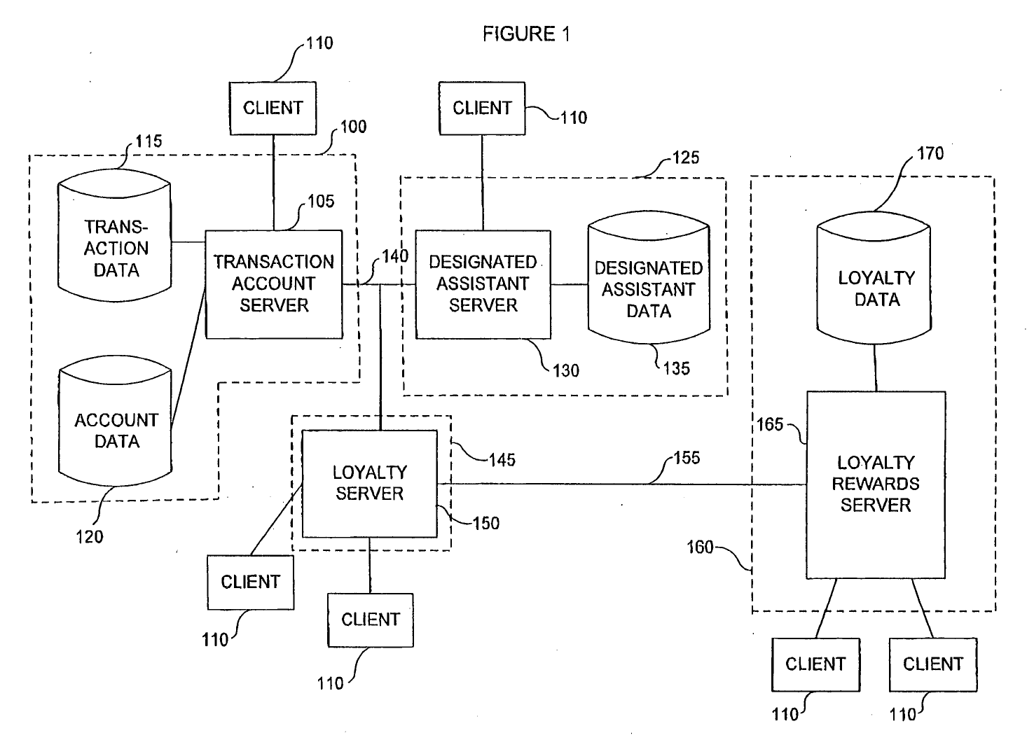

FIG. 1 is a system diagram of an exemplary embodiment of the present invention. The issuer of the transaction instrument maintains a transaction accounts system 100, which processes and stores information data relating to the transaction accounts. Transaction accounts system 100 may include, for example, a server 105 configured to communicate with a number of client computers 110 via a network (depicted in FIG. 1 as lines connecting the server to the client computers), e.g., a local area network (LAN), or a mainframe computer configured to communicate with a number of terminals.

Transaction accounts system 100 includes a transaction database 115 and an account database 120. During operation, any data regarding a particular account holder is stored in the appropriate corresponding database associated with transaction accounts system 100, with server 105 processing the data among the several linked databases and clients.

Account database 120 stores identification, personal, and contact information provided to the transaction instrument issuer by account holders. This account information may, for example, include a holder's name, residence, Social Security number, employer, contact information, and the like.

Transaction database 115 stores all information relating to transactions conducted with the financial transaction instrument linked to the transaction account. For example, when an account holder makes a purchase from a merchant using the transaction instrument, data relating to the transaction is transmitted by the merchant to the account issuer. Assuming the transaction is approved, the card issuer pays the merchant and bills the account holder. The transaction data is stored in transaction database 115 for these purposes and for record keeping purposes, among other uses.

Of course, the present invention is not limited to the databases mentioned above, and additional databases for storing other information may be provided as part of transaction accounts system 100. These databases may be stored as a single database or as physically or logically separate databases, as depicted in FIG. 1. The physical storage device or devices may be either internal or external to transaction accounts system server 105.

As noted above, there are one or more client computers 110 associated with transaction accounts system 100 that are capable of accessing this system to retrieve information from databases 115 and 120. It is to be understood that although only one client 110 is depicted in FIG. 1, there may be numerous clients connected to transaction accounts server 105 via various types of network and direct connections.

Also illustrated in FIG. 1 is a designated assistant system 125 in communication with the transaction accounts system 100 via a network, e.g., a LAN or the Internet. The designated assistant system 125 may, for example, include a server 130 configured to communicate via a LAN, or any other conventionally known network, with a number of client computers 110. In such an embodiment, the server 130 processes and stores information relating to designated assistants who are authorized to manage transaction accounts on behalf of the account holders.

System 125 includes a designated assistant database 135 that stores management data, which is identification, personal, and contact information relating to the designated assistants. Database 135 may be implemented, for example as a Microsoft Access™ database running on a server. The physical device or devices on which designated assistant database 135 is stored may be either internal or external to the designated assistant system server.

The management data may include, for example, the assistant's name, Social Security number, contact information, the level of access at which they are authorized to manage a transaction account, and the like. This data, among other uses, allows the identity of the designated assistant to be verified by the account issuer. This data also allows the account issuer to provide the designated assistant with general information relating to the management of accounts by assistants. For example, when an assistant is first designated, the account issuer may send the assistant information on the various means of accessing the account holder's transaction account and the terms and conditions relating to such access.

As noted above, a number of client computers 110 are connected to designated assistant system 125 to allow access to the designated assistant data. For example, a customer service operator working for the transaction instrument issuer may access the designated assistant information to allow the operator to verify that a caller has proper authorization to assist in managing the account. Alternatively, as discussed below, the operator may access the designated assistant information through transaction accounts system 100.

There is further provided a loyalty system 145 that is electronically linked over a network, such as a LAN or the Internet, to both the designated assistant and transaction accounts systems. Loyalty system 145 operates in conjunction with the two other systems 100 and 125, processing loyalty rewards information for both account holders and designated assistants, and includes a loyalty server 150, programmed to access data from both the transaction accounts system and designated assistant system. This data is relayed from loyalty server 150 over a network 155 to a loyalty rewards system 160. As above, the network 155 may be any conventionally-known network, e.g., the Internet.

Loyalty server 150 can be accessed by a number of client computers 110, as illustrated in FIG. 1. The present invention does not contemplate a particular limit on the number of such client computers that may be linked to loyalty server 150. Most often, these client computers will be located on the premises of the transaction instrument issuer for use by operators, and can appear in a number of embodiments including personal computers, workstations, remote-access terminals, and the like.

In FIG. 1, transaction accounts system 100 and designated assistant system 125 are connected by an electronic link 140, such as a network or other type of electronic link. In this particular embodiment, link 140 allows information to pass between the systems in order to synchronize records in both systems. For example, when the transaction instrument issuer receives the. designation of an assistant from an account holder, the authorization may be automatically relayed from designated assistant system 125 to transaction accounts system 100 for appropriate processing, updating, and storage in account database. 120. Link 140 between the two systems may allow for automatic electronic updating of designated assistant information in transaction accounts system 100.

Loyalty server 150 is connected to both transaction account and designated assistant servers 105 and 130, respectively, by means of electronic link, such as a network or any other electronic link. The links enables information to be shared electronically among the three systems in order to synchronize all three systems. This network configuration further allows information from any one of the databases associated with the systems to be accessed and transmitted through the loyalty server 150.

There is further depicted loyalty rewards server 165 as part of loyalty rewards system 160, which is electronically connected to loyalty database 170 and can be accessed by client server computers 110. The loyalty system 160 may be part of the transaction instrument issuer or, in an alternate embodiment, may be a distinct entity, separate from the transaction instrument issuer. In the latter case, the rewards information for both the designated assistant and the account holder would be communicated regularly to this separate vendor, via a network 155. For example, American Express Company, as the transaction instrument issuer, may contract with an independent vendor such as Aeroplan, to maintain loyalty rewards for both its card members and their designated assistants based on transaction information supplied by American Express.

When the information is received by loyalty rewards system 160, it is classified, tabulated and stored by server 165 in loyalty database 170 for both the designated assistant and the account holder. This information may be in the form of any sort of electronic data. The amount of loyalty rewards is based on the number of transactions made and/or the amount spent using the financial transaction instrument. Specifically, when either the designated assistant and/or the account holder arrives at a threshold amount of necessary transactions or purchases, the transaction instrument issuer is informed that specific loyalty rewards have become available to or may be redeemable by the party having reached the threshold for a particular loyalty benefit. For instance, the party may be eligible for cash back on a specific purchase or free merchandise.

To perform the above operations, loyalty rewards server 165 may be configured to communicate with a plurality of client computers 110 over any sort of conventionally-known network or, likewise, a mainframe computer configured to communicate with a plurality of terminals. Server 165 processes loyalty data by first matching transaction information with the allocated loyalty reward(s) from a particular partner, and subsequently awarding such loyalty benefits to the account holder and/or the designated assistant, all based on the information received. Loyalty rewards server 165 is connected to loyalty database 170. Loyalty database 170 stores data related to each designated assistant's and account holder's prior loyalty rewards and data related to transactions since the last award. The purpose of this is for periodic tabulation and notification when a given individual is eligible to collect or redeem a loyalty reward.

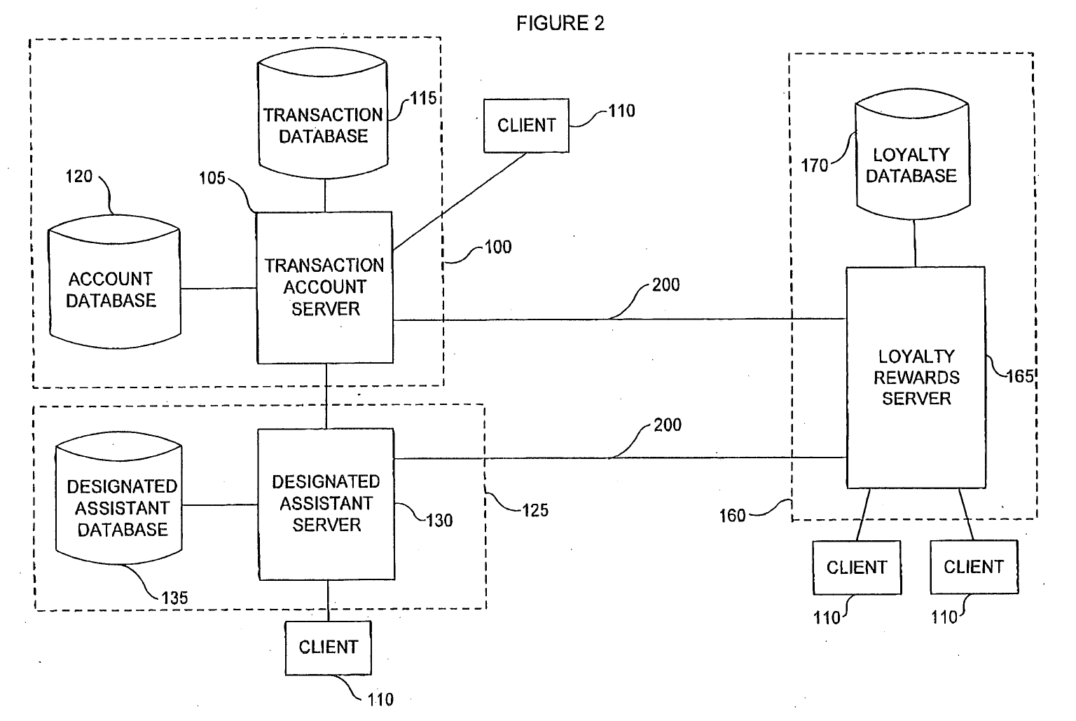

Another embodiment of the present invention is illustrated in FIG. 2. Here, only transaction accounts server 105 and designated assistant server 130 are each linked to loyalty rewards server 165. That is, in this embodiment the loyalty system is absent altogether and, instead, information from both the transaction account and designated assistant servers is transmitted directly to loyalty rewards server 165 for processing. The information is conveyed by means of an electronic link 200, and may be transmitted either periodically (e.g., monthly) or otherwise simultaneously as new transactions occur and are processed by the transaction instrument issuer.

Once the data from both the transaction account and the designated assistant servers 105 and 130 is stored by loyalty rewards server 165, it may be accessed by loyalty rewards operators through a number of client computers 110. Here, too, the present invention is not limited to any particular number of client computers 110.

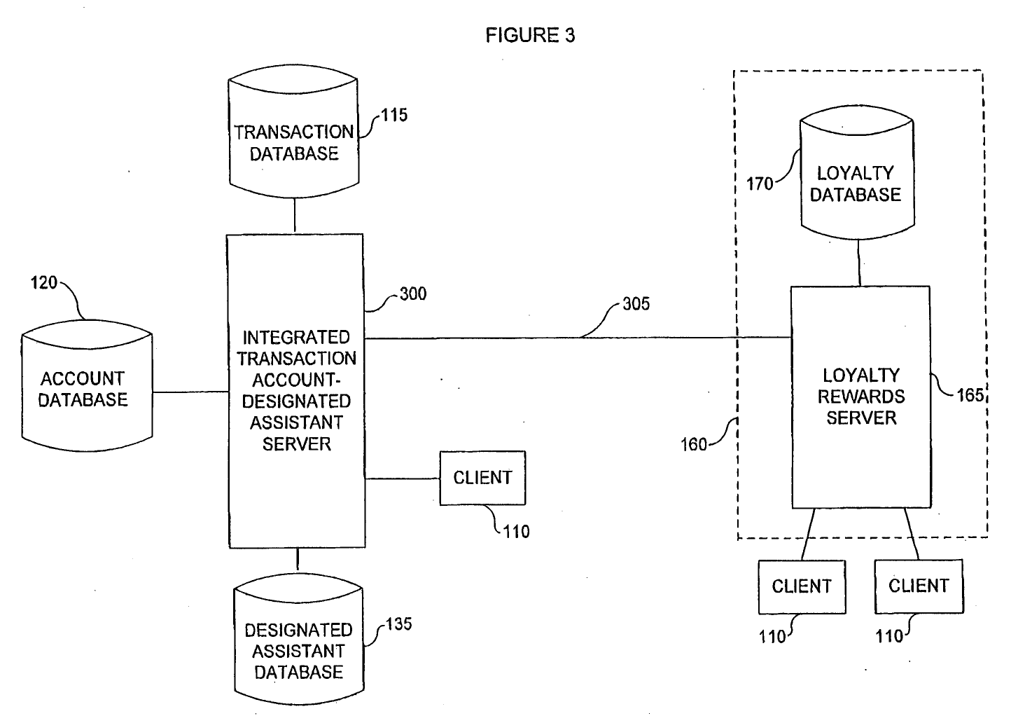

In other embodiments, as illustrated in FIG. 3, integrated server 300 is in connection with a number of databases, including account database 120, transaction database 115, and designated assistant database 135. Of course, the present invention is not limited to only these databases, and could certainly accommodate additional databases. The present databases may be stored as either a single or, otherwise, as physically or logically separate databases. Moreover, both an internal and external physical storage device or devices are contemplated by the present invention. Advantageously, integrating the two separate servers obviates the need for manual updating of each respective server with the corresponding designation and transaction or account data.

Integrated server 300 can also be accessed at several locations through client computers 110. As with the other embodiments, client computers 110 are not limited to any particular form, and can be implemented as personal computers, terminals, workstations, etc.

The integrated server 300 is in connection with loyalty rewards server 165 by means of the electronic link 305, such as a network or other type of electronic link. Link 305 enables information on the transactions carried out by either the designated assistant or the account holder to be transmitted directly to loyalty rewards server 165. The information may be supplied to the server either periodically or automatically whenever new transaction information is received by the transaction instrument issuer.

Loyalty rewards server 165, connected to integrated server 300, is associated with loyalty database 170 into which information such as the dates of transaction that are to be taken into consideration in determining rewards, and the amounts spent in those transactions, is entered, and can later be accessed through any number of client computers 110. Alternatively, if rewards are given based on the number of transactions but not the amounts spent, then the amounts need not be stored in loyalty database 170. In any event, any data that is to be used in determining what rewards are to be given, and when, is stored in loyalty database 170. As new information is received from integrated server 300, loyalty rewards server 165 disseminates the data in order to match the appropriate loyalty reward for a transaction executed by either an account holder or a designated assistant. Once processed and stored, the loyalty information can be accessed from client computers 110 for any sort of requested update;

III. Process

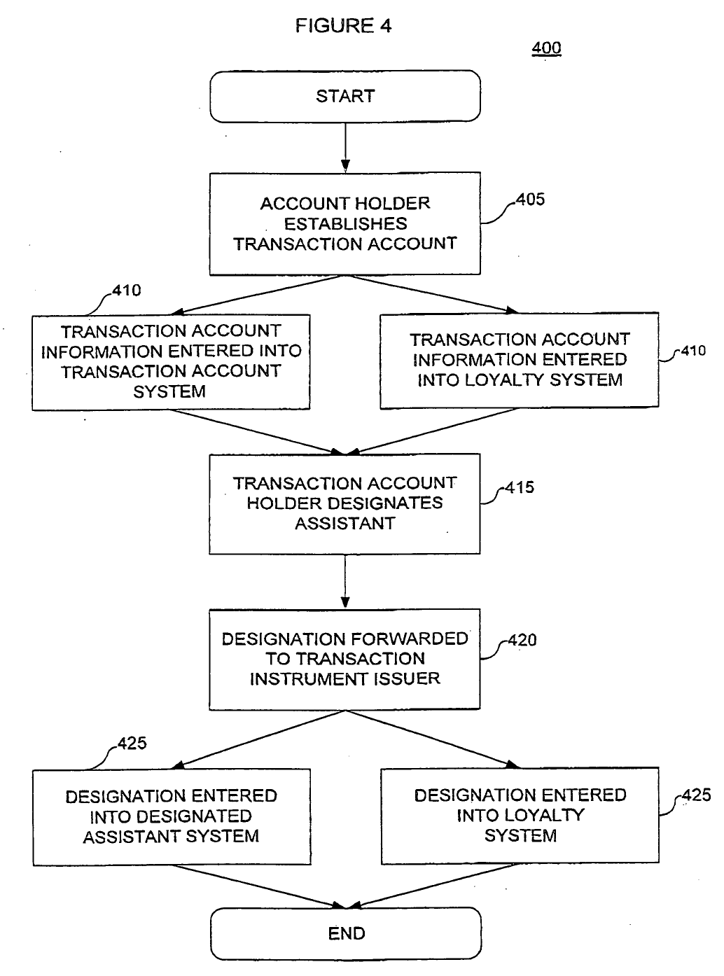

FIG. 4 is a flowchart illustrating a designated assistant enrollment process 400 in accordance with an embodiment of the present invention. The process may begin with a customer establishing a transaction account associated with a financial transaction instrument (step 405), or alternatively, the customer may have an existing transaction account. The customer may establish the transaction account with a transaction instrument issuer by completing an application, which may be, for example, a paper form that is mailed or sent by facsimile to the account issuer or may be an online form transmitted to the account issuer via the Internet. The account issuer enters the information provided by the customer into a transaction accounts system (step 410) that, as discussed above, handles the storage and processing of transaction and account data for accounts linked to the financial transaction instrument.

At the same time, the transaction instrument issuer will separately enter the information into a loyalty system (step 410). That is, the transaction instrument issuer will create a first, district loyalty account associated with the transaction account for the transaction account holder. Thus, two distinct systems maintain information for account holders. If the customer already has a transaction account, the information would likewise already be entered within the corresponding loyalty system.

Once a transaction account is established, the account holder is able to designate an assistant to administer the account on their behalf (step 415). To do so, the account holder may complete a designated assistant enrollment form, which is forwarded to the transaction instrument issuer (step 420). The form may be for example, a paper form that is mailed or sent by facsimile to the account issuer or may be an online form transmitted to the account issuer via the Internet. Alternatively, the customer may designate an assistant as part of completing the initial transaction instrument application by filling in a particular portion of the form provided for that purpose.

The assistant enrollment form, whether separate from or combined with the initial application, provides the procedural and legal basis necessary to effectuate authorization to enable the designated individual to manage or administer the transaction account, including specifying the terms and conditions applicable to this form of account management. It should be understood that the assistant enrollment form is not limited to any specific format or medium. Information relating to the designated assistant is stored in the transaction instrument issuer's designated assistant system, so that it can be accessed by customer service operators for verification purposes.

In designating an assistant, the account holder may select a level of management access at which the assistant is to be authorized to manage the transaction account. For example, the access level may be selected on the designated assistant enrollment form. Each of the levels corresponds to a predetermined set of management functions the assistant is allowed to perform. Alternatively, the system may provide only a single level of access for designated assistants, which includes a predetermined subset of management functions.

If multiple access levels are provided, the broadest level may give the designated assistant unrestricted access to perform any function associated with the transaction account that can be performed by the account holder. Alternatively, the broadest level of access may exclude certain functions, such as the ability to change the mailing address for the account. The other levels restrict the assistant to particular subsets of the management functions associated with the transaction account.

For example, the level of management access may permit the designated assistant to perform all functions available to the account holder, but may exclude the authority to make purchases or to alter the account holder's personal information, such as the account mailing address. As a further example, an account holder may restrict the designated assistant to the level of viewing and retrieving transaction information and conducting general account inquiries.

The designation information is entered by the account issuer into a designated assistant system as management data (step 425). This management data may, by way of non-limiting example, take the form of an electronic entry created within the transaction instrument issuer's designated assistant database (see element 135 in FIGS. 1-3). The management data may include personal and contact information relating to the designated assistant, such as the name of the assistant, their Social Security number, address, telephone number, e-mail address, and any other identifying information the transaction account issuer may require. When the designated assistant seeks to execute a management instruction relating to the account, for example, by making a phone call to the transaction instrument issuer, the customer service operator accesses the management data in the designated assistant system to verify the identity of the assistant and their authority to administer the transaction account.

The account issuer likewise enters the provided information about the designated assistant into the loyalty system (step 425). As above, here too, entering the designation into the loyalty system may take the form of creating an electronic entry within the loyalty database (see element 170 in FIGS. 1-3). In this way, a second, distinct loyalty account associated with the transaction account is created, this time for the designated assistant.

In this embodiment, the transaction account issuer maintains both a loyalty system and a loyalty reward server with entries for the account holder and designated assistant. Accordingly, there are two distinct loyalty accounts for each party, both of which are associated with the account holder's transaction account.

However, in an alternative embodiment, the information regarding the account holder's and designated assistant's loyalty rewards may be transferred to the loyalty rewards system of a separate vendor, after first being input into the transaction instrument issuer's loyalty and designated systems.

The reward program of the present invention is not limited to any particular loyalty plan. For instance, when a transaction with the financial transaction instrument is executed, both the account holder and designated assistant receive a loyalty reward, regardless of who in fact performed the actual transaction. Both parties earn rewards on a single transaction. However, the account holder and designated assistant may each be rewarded at different levels, so that their respective total accumulated points may vary. To illustrate, it may be the case that under a given reward program, the account holder earns a point for every dollar spent, while the designated assistant earns only a half-point on the same dollar. Conversely, it is possible that both parties earn the same value for each transaction. In any event, the present invention is not limited to any particular reward scheme.

In addition to the steps described above for designating an assistant, the account holder may also change the designated assistant, or cancel the authorization of a designated assistant altogether. To do so, the account holder may, for example, submit an appropriate form or access a particular webpage in the online account management system. Such forms are not limited to any particular format or medium.

The account holder may designate more than one assistant to manage or administer their transaction account. Under such an embodiment, the account holder proceeds according to the process described above, but may, for example, submit a separate designation form for each additional assistant, indicating on the form that the designation is made in addition to any previous designations. Alternatively, a single form may provide for the designation of multiple assistants. Moreover, the present invention may allow the account holder to set different levels of access for each of their designated assistants, thus allowing greater flexibility in distributing responsibility for account management functions.

For every additional designation of an assistant submitted, the transaction instrument issuer would in turn establish a loyalty account for that assistant. Accordingly, the present invention makes it possible for multiple designated assistants to earn loyalty rewards for a single transaction performed on a transaction account. As above, each assistant may collect rewards at different levels.

According to the present invention, it is also the case that a single assistant may be designated by more than one account holder. That is, in such instance the designated assistant would be authorized to manage a plurality of distinct transaction accounts, each linked to a separate transaction account instrument belonging to a separate account holder. Under this particular arrangement, the present invention may additionally enable the account holders each to select a different level of management access at which the common designated assistant is authorized to administer their respective transaction account.

For this arrangement, the transaction instrument issuer would also establish a plurality of separate loyalty accounts for the designated assistant, each corresponding to the particular transaction account of the plurality of account holders. However, in this instance the present invention makes it possible for the common designated assistant to combine various loyalty rewards from the different loyalty accounts in order to be increase their eligibility for collecting some loyalty benefit by having arrived at a threshold amount of rewards or spending.

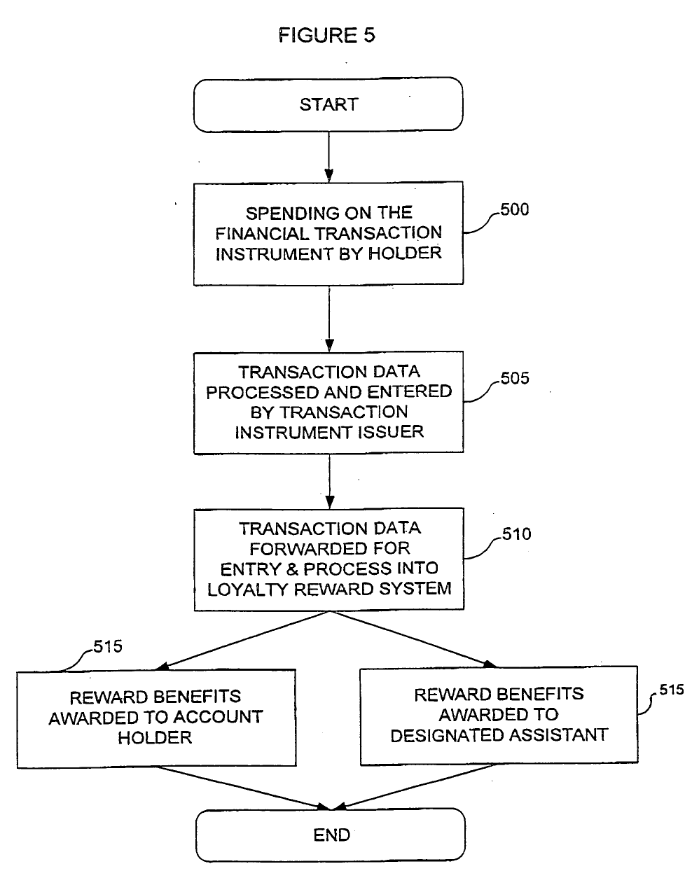

FIG. 5 is a flowchart illustrating the award of loyalty benefits resulting from management of the transaction account, including purchases made with the financial transaction instrument. Generally, the amount of loyalty rewards increases for both the designated assistant and the account holder as the amount of spending increases on the financial transaction instrument with particular partners. The process may begin, for example, with a corporate executive having an existing corporate card transaction account and associated loyalty account with American Express, the transaction instrument issuer. Additionally, the executive has previously designated an assistant, for whom American Express also maintains a loyalty account.

The executive makes a specific purchase (e.g., buying a plane ticket from a particular airline partner for an upcoming business trip) using their corporate card (step 500). This purchase increases the amount of spending on the transaction account as a result of using the financial transaction instrument. Because the airline is a partner with American Express, the purchase also results in a gain of some loyalty reward for the executive.

Information on the ticket purchase is received by the transaction instrument issuer, American Express (step 505). The information is entered into the transaction database associated with the transaction accounts system (see element 1 15 in FIGS. 1-3). Among the data entered is the purchase price, the date of transaction, and the precise merchant involved.

Data of the transaction is also entered into a loyalty server. That way, the loyalty reward offered for the particular purchase, such as perhaps frequent flier miles, is present for both the executive as well as their designated assistant. In this particular example, once an electronic record of the transaction in question has been created, American Express relays the information to a separate entity that maintains a loyalty rewards system (step 510).

When transaction information is entered into a loyalty rewards server it is subsequently processed, with the corresponding frequent flier miles being awarded to both the executive as a first reward, and their designated assistant as a second reward associated with the executive's transaction account (step 515). By way of non-limiting example, this award of the loyalty benefit may occur as an electronic point value being input into the loyalty database for the executive and their designated assistant. Such point value would be added to the already existing totals of each individual.

IV. Example Implementations

The present invention (i.e., system 100, process 400 or any part(s) or function(s) thereof) may be implemented using hardware, software or a combination thereof and may be implemented in one or more computer systems or other processing systems. Useful machines for performing the operation of the present invention include general purpose digital computers or similar devices.

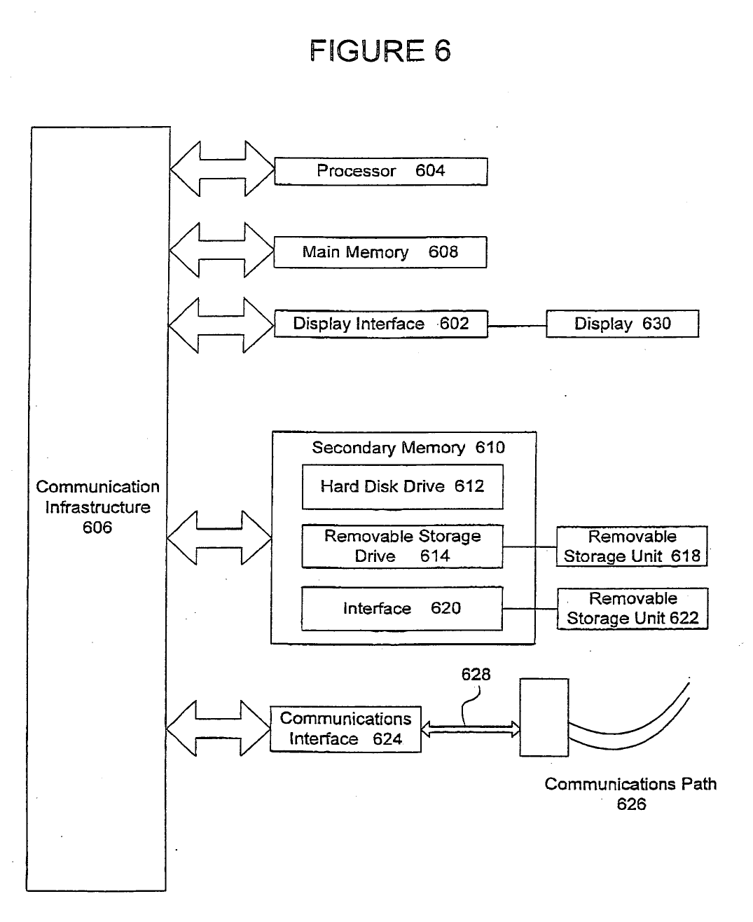

In fact, in one embodiment, the invention is directed toward one or more computer systems capable of carrying out the functionality described herein. An example of a computer system 600 is shown in FIG. 6.

Computer system 600 includes one or more processors, such as processor 604. Processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from communication infrastructure 606 (or from a frame buffer not shown) for display on display a unit 630.

Computer system 600 also includes a main memory 608, preferably random access memory (RAM), and may also include a secondary memory 610. Secondary memory 610 may include, for example, a hard disk drive 612 and/or a removable storage drive 614, representing a floppy disk drive, a magnetic tape drive, an optical disk drive, etc. Removable storage drive 614 reads from and/or writes to a removable storage unit 618 in a well known manner. Removable storage unit 618 represents a floppy disk, magnetic tape, optical disk, etc., which is read by and written to by removable storage drive 614. As will be appreciated, removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. Signals 628 are provided to communications interface 624 via a communications path (e.g., channel) 626. This channel 626 carries signals 628 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable computer system 600 to perform the features of the present invention, as discussed herein. In particular, the computer programs, when executed, enable processor 604 to perform the features of the present invention. Accordingly, such computer programs represent controllers of computer system 600.

In an embodiment where the invention is implemented using software, the software may be stored in a computer program product and loaded into computer system 600 using removable storage drive 614, hard drive 612 or communications interface 624. The control logic (software), when executed by processor 604, causes processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for rewarding both a holder of a transaction account linked to a financial transaction instrument, and an assistant who has been designated by the transaction account holder to manage the transaction account, comprising the steps of:
creating a first loyalty account associated with the transaction account holder;
creating a second loyalty account associated with the assistant;
providing a first reward to the first loyalty account based on at least one transaction made using the financial transaction instrument ; and
providing a second reward to the second loyalty account, based on the at least one transaction made using the financial transaction instrument,
whereby the transaction account holder and the assistant can each participate in a loyalty program through use of the financial transaction instrument.

2. The method of claim 1, wherein providing the first reward to the first loyalty account and the second reward to the second loyalty account is additionally based on a relationship of a partner with the loyalty program.

3. The method of claim 1, wherein the assistant is an employee working for the account holder.

4. The method of claim 1, further comprising the step of accepting a designation of at least one level of management access at which the assistant is authorized to manage at least a portion of the transaction account.

5. The method of claim 1, wherein said step of creating for the transaction account holder the first loyalty account and said step of creating for the assistant a second loyalty account are performed at a single integrated server.

6. The method of claim 1, further comprising the step of creating for a third loyalty account associated with a second assistant.

7. The method of claim 6, further comprising the step of additionally providing a third reward to the third loyalty account, based on the at least one transaction made using the financial transaction instrument.

8. The method of claim 1, wherein said step of creating for a transaction account holder a first loyalty account is performed multiple times to create respective first loyalty accounts for each of a plurality of transaction account holders, who have each designated the same assistant, and wherein said step of creating for the assistant a second loyalty account is performed to create a single loyalty account for the assistant corresponding to the first loyalty accounts of that plurality of transaction account holders.

9. A system for rewarding a holder of a transaction account linked to a financial transaction instrument, and an assistant who has been designated by the transaction account holder to manage the transaction account, comprising:
a database storing information relating to a first loyalty account, associated with the transaction account holder, and a second loyalty account, associated with the assistant; and
a processor for providing a first reward to the first loyalty account based on at least one transaction made using the financial transaction instrument and for providing a second reward to the second loyalty account, based on the at least one transaction made using the financial transaction instrument,
whereby the transaction account holder and the assistant can each participate in a loyalty program through use of the financial transaction instrument.

10. The system of claim 9, wherein said processor's crediting the first reward to the first loyalty account and the second reward to the second loyalty account is additionally based on a relationship of a partner with the loyalty program.

11. The system of claim 9, further comprising a database for storing a designation of at least one level of management access at which the assistant is authorized to manage at least a portion of the transaction account.

12. The system of claim 9, wherein said processor establishes the first loyalty account and the second loyalty account at a single integrated server.

13. The system of claim 9, wherein said database also stores information relating to a third loyalty account associated with the transaction account, the third loyalty account being for a second assistant designated by the transaction account holder.

14. The system of claim 13, wherein said processor additionally credits a third reward to the third loyalty account of the second assistant, based on at least one transaction made by the transaction account holder using the financial transaction instrument.

15. The system of claim 9, wherein said database stores information relating to respective first loyalty accounts of each of a plurality of transaction account holders, who have each designated the same assistant, and stores information relating to a second loyalty account for that assistant.

16. A computer program product comprising a computer usable medium having control logic stored therein for causing a computer to reward a holder of a transaction account linked to a financial transaction instrument, and an assistant who has been designated by the transaction account holder to manage the transaction account, said control logic comprising:
first computer readable program code means for causing the computer to create a first loyalty account associated with the transaction account holder;
second computer readable program code means for causing the computer to create a second loyalty account associated with the assistant;
third computer readable program code means for causing the computer to provide a first reward to the first loyalty account based on at least one transaction made using the financial transaction instrument; and
fourth computer readable program code means for causing the computer to provide a second reward to the second loyalty account of the assistant, based on the at least one transaction made using the financial transaction instrument,
whereby the transaction account holder and the assistant can each participate in a loyalty program through use of the financial transaction instrument.

17. The computer program product of claim 16, wherein crediting the first reward to the first loyalty account and the second reward to the second loyalty account is additionally based on a relationship of a partner with the loyalty program.

18. The computer program product of claim 16, further comprising:
fourth computer readable program code means for causing the computer to accept a designation of at least one level of management access at which the assistant is authorized to manage the transaction account.

19. The computer program product of claim 16, further comprising:
fourth computer readable program code means for causing the computer to create the first loyalty account and the second loyalty account at a single integrated server.

20. The computer program product of claim 16, further comprising:
fourth computer readable program code means for causing the computer to create for a second assistant a third loyalty account associated with the transaction account.

21. The computer program product of claim 20, further comprising:
fourth computer readable program code means for causing the computer additionally to credit a third reward to the third loyalty account of the second assistant, based on at least one transaction made by the transaction account holder using the financial transaction instrument.

22. The computer program product of claim 16, wherein said first computer readable program code means is also for causing the computer respective first loyalty accounts for each of a plurality of transaction account holders, wherein said second computer readable program code means is also for causing the computer to create for the assistant a second loyalty account associated with each of those plural transaction accounts.
